(19) United States
(12) Patent Application Publication
(10) Pub. No.: US 2020/0263371 A1
(43) Pub. Date: Aug. 20, 2020

(54) PAVEMENT COMMUNICATION PLATFORM AND METHODS FOR USE THEREOF

(71) Applicants: Brandon Steele JOHNSTON, Holly Lake Ranch, TX (US); Jacob Nelson HARGRAVE, Kingwood, TX (US)

(72) Inventors: Brandon Steele JOHNSTON, Holly Lake Ranch, TX (US); Jacob Nelson HARGRAVE, Kingwood, TX (US)

(21) Appl. No.: 16/349,606

(22) PCT Filed: Jan. 25, 2019
(86) PCT No.: PCT/US19/15217

§ 371 Date: May 13, 2019

Related U.S. Application Data
(60) Provisional application No. 62/723,426, filed on Aug. 27, 2018.

(51) Int. Cl. E01F 9/512; E01F 9/559; E01C 11/24; E01C 23/18; E01F 9/576; E01F 9/582; B32B 7/12; B32B 3/30; G08G 1/09

(52) U.S. Cl. CPC E01F 9/512; E01F 9/559; E01C 11/24; E01C 23/185; G08G 1/09; E01F 9/582; B32B 7/12; B32B 3/30; E01F 9/578

(57) ABSTRACT

A pavement communication platform is disclosed herein, as well as methods of using the same. A benefit to the pavement communication platform can be providing information, such as advertisements or instructions, to the public in connection with a pavement platform.

### TECHNICAL FIELD

A pavement communication platform is disclosed herein, as well as methods of using the same. A benefit to the pavement communication platform can be providing information, such as advertisements or instructions, to the public in connection with a pavement platform.

### BACKGROUND

Pavement markings are widely used in connection with the movement and location of vehicles in paved areas. Various approaches are used for such pavement markings, including the use of painted lines to indicate the boundaries for vehicle parking or movement. For example, painted lines or stripes on a pavement surface often delineate the boundaries of parking spaces in parking lots.

### SUMMARY

Embodiments herein are directed to pavement communication platforms, compositions comprising the same, and related methods of communicating.

In an aspect, the pavement communication platform comprises a pavement adhesive and a pavement shell, wherein the pavement shell has a top surface and a bottom surface, and at least a portion of the bottom surface is adhered to the pavement adhesive, wherein the pavement shell has at least one pressure-release ridge that extends from the top surface through a material of the pavement shell to the bottom surface and extends from about 70% to 100% of a length of the pavement shell; and wherein the pavement shell has at least one traction feature on the top surface.

In certain embodiments, the height of the pavement communication platform ranges from about 0.5 cm to about 3.0 cm. In certain embodiments, the thickness of the pavement shell ranges from about 0.3 cm to about 2.0 cm. In certain embodiments, the width of the pavement shell ranges from about 8.0 cm to about 18.0 cm. In certain embodiments, the at least one traction feature has a traction height of about 0.7 mm to about 1.3 mm and a traction width of about 1.3 mm to about 2.0 mm.

In certain embodiments, the at least one pressure-release ridge has a ridge width ranging from about 10.0 mm to about 15.0 mm and a ridge height that extends from the top surface by from about 4.0 mm to 8.0 mm.

In certain embodiments, the pavement shell has at least two traction features, and the at least two fraction features are spaced an average of about 4.0 mm to about 8.0 mm apart to form a traction area. In certain embodiments, the traction area covers from about 80% to 100% of the top surface of the pavement shell.

In certain embodiments, the material of the pavement shell includes a polycarbonate, a polyurethane, a polymethyl methacrylate, a polyethylene, a thermoplastic elastomer (TPE), a rubber, an acrylic having a molecule weight from about 2.5 million to about 9.5 million Daltons, a tempered glass, or a combination thereof. In certain embodiments, the pavement adhesive includes a polybutene, a polybutelene-1, a polyisobutene, an epoxy, or a combination thereof.

In certain embodiments, at least one of the pavement adhesive and the pavement shell is formed from a single material.

In certain embodiments it is provided that the pavement adhesive is a tacky adhesive, wherein the pavement communication platform further comprises a removable backing adhered to the pavement adhesive.

In other embodiments, the pavement communication platform further comprises a sticker adhered to the top surface of the pavement communication platform, wherein the sticker includes a sticker base material and a sticker adhesive layer, wherein the sticker base material includes a polyvinylchloride, a polyester, or a combination thereof; and the sticker adhesive includes a permanent adhesive.

In still other embodiments, the pavement communication platform further comprises a communication display, wherein the communication display includes a fastener mounted of the top surface of the pavement communication platform.

In additional embodiments, the pavement communication platform further comprises a communication display, wherein the communication display includes an array of lights that is mounted on the top surface of the pavement shell or visible through the top surface of the pavement shell.

A method of communicating is disclosed herein. In an embodiment, the method includes adhering a pavement communication platform to a pavement; and displaying a message on the pavement communication platform, wherein the pavement communication platform includes a pavement adhesive and a pavement shell, wherein the pavement shell has a top surface and a bottom surface, and at least a portion of the bottom surface is adhered to the pavement adhesive, wherein the pavement shell has at least one pressure-release ridge that extends from the top surface through a material of the pavement shell to the bottom surface and extends from about 70% to 100% of a length of the pavement shell; and wherein the pavement shell has at least one traction feature on the top surface.

In an aspect, provided that the pavement adhesive is a tacky adhesive and the pavement adhesive is adhered to a removable backing, adhering the pavement communication platform to the pavement by detaching the removable backing from the pavement adhesive and placing the pavement adhesive in contact with the pavement.

In an aspect, provided that the pavement adhesive is a non-tacky adhesive, adhering the pavement communication platform to the pavement by heating the pavement adhesive to from about 121° C. to about 176° C. and placing the pavement adhesive in contact with the pavement.

In an embodiment, the method includes displaying the message by adhering a sticker having a message to a top surface of the pavement shell, wherein the sticker includes a sticker base material and a sticker adhesive layer, wherein the sticker base material includes a polyvinylchloride, a polyester, or a combination thereof; and the sticker adhesive includes a permanent adhesive.

In an embodiment, provided that the pavement communication platform includes a communication display, wherein the communication display includes a fastener mounted on the top surface of the pavement communication platform, displaying the message by fastening a material having a message onto the communication display. In an embodiment, provided that the pavement communication platform includes a communication display, wherein the communication display includes an array of lights that is mounted on the top surface of the pavement shell or visible through the top surface of the pavement shell, displaying a message by illuminating at least part of the array of lights.

### BRIEF DESCRIPTION OF THE DRAWINGS

The foregoing summary, as well as the following detailed description of the embodiments, will be better understood when read in conjunction with the attached drawings. For the purpose of illustration, there are shown in the drawings some embodiments, which may be preferable. It should be understood that the embodiments depicted are not limited to the precise details shown. The embodiments are not drawn to scale.

FIG. 1 shows a schematic cross section of an embodiment of an end portion of a pavement communication platform having a removable backing.

FIG. 2 shows a schematic cross section of an embodiment of an end portion of a pavement communication platform from a side view.

FIG. 3 shows a schematic cross section of an embodiment of an end portion of a pavement communication platform having a communication display that includes a fastener.

### DETAILED DESCRIPTION

Unless otherwise noted, all measurements are in standard metric units.

Unless otherwise noted, all instances of the words “a,” “an,” or “the” can refer to one or more than one of the word that they modify.

Unless otherwise noted, the phrase “at least one of” means one or more than one of an object. For example, “at least one of the pavement adhesive and the pavement shell” means a pavement adhesive, a pavement shell, or any combination thereof.

Unless otherwise noted, the term “about” refers to ±10% of the non-percentage number that is described, rounded to the nearest whole integer. For example, about 100 mm, would include 90 to 110 mm. Unless otherwise noted, the term “about” refers to ±5% of a percentage number. For example, about 20% would include 15 to 25%. When the term “about” is discussed in terms of a range, then the term refers to the appropriate amount less than the lower limit and more than the upper limit. For example, from about 100 to about 200 mm would include from 90 to 220 mm.

Unless otherwise noted, properties (height, width, length, ratio etc.) as described herein are understood to be averaged measurements.

### Embodiments of Pavement Communication Platforms

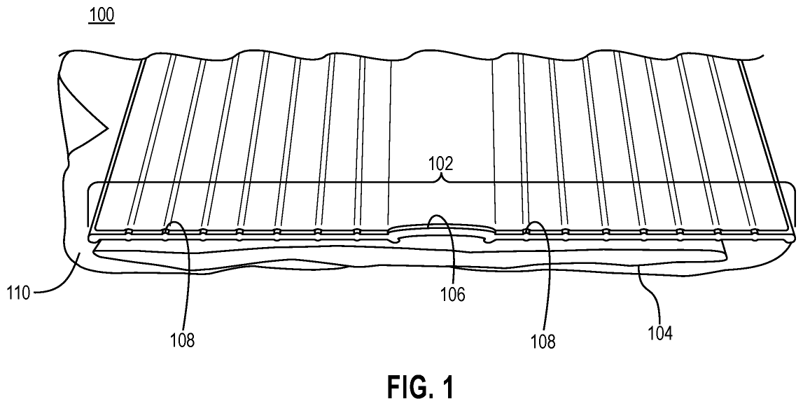

An embodiment of a pavement communication platform as disclosed herein is shown in FIG. 1. A pavement communication platform 100 has a pavement shell 102 that can be bound to a pavement with a pavement adhesive 104. The pavement shell has a pressure release ridge 106 and a traction feature 108 on a top surface. In an embodiment, provided that the pavement adhesive is a tacky adhesive, the pavement communication platform can include a removable backing 110 in contact with the pavement adhesive.

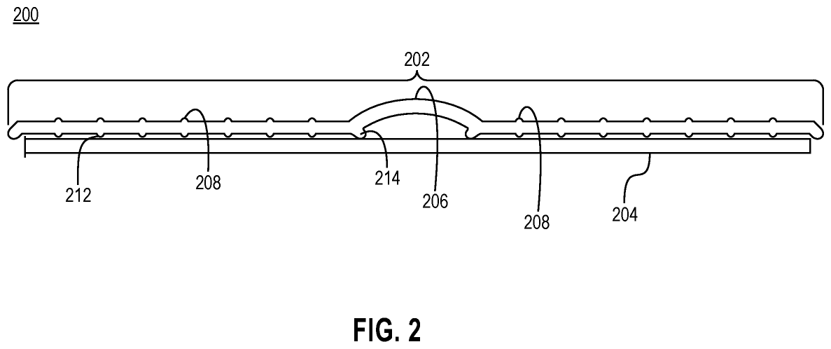

An embodiment of a pavement communication platform as disclosed herein is shown in FIG. 2. A pavement communication platform 200 has a pavement shell 202 having a pavement adhesive 204 on a bottom surface, and a pressure-release ridge 206. The pavement shell 202 has a traction feature 208 on a top surface, adhesion contours 212 on a bottom surface, and pressure relief supports 214 on a bottom surface.

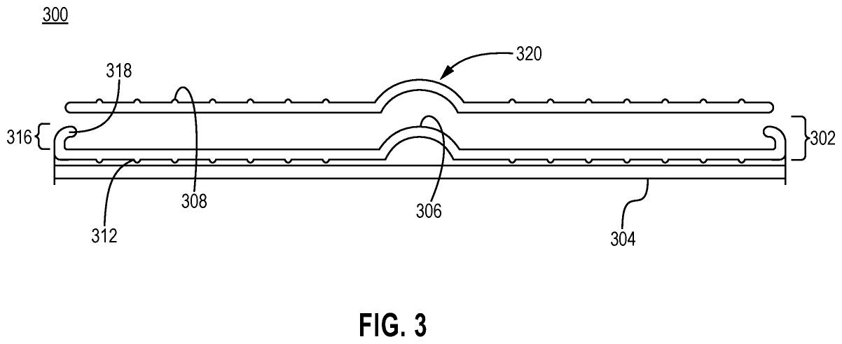

An embodiment of a pavement communication platform as disclosed herein is shown in FIG. 3. A pavement communication platform 300 has a pavement shell 302 and a communication display 316. The pavement shell 302 has a pavement adhesive 304 and adhesion contours 312 on a bottom surface. Pavement shell 302 also has a pressure-release ridge 306 and a fastener 318. The communication display 316 has a traction feature 308 on a top surface a message 320.

Conventional parking stripes and signs are painted on the ground. However, most parking stripes convey no information other than to mark the boundaries of a parking space. Alternatively, when pavement strips are painted to convey a message, that message cannot be changed without painting over the previous message. This format may be suitable for conveying a permanent instruction, such as “no parking” or “loading zone.” However, messages painted directly onto the ground are not generally suitable for advertising or other types of message, because advertising needs change over time. For example, many advertising models include selling advertising space for one or more units of time. Also, advertisers often change messages from one campaign to another. Frequently repainting messages onto pavement can be expensive, inefficient, and due to the chemicals required, dangerous to the environment. For example, painting a portion of a parking garage usually requires paying multiple workers, dedicating equipment, and shutting off that section of the parking lot to avoid accidentally painting onto nearby cars. Also, painting over the ground tends to reduce traction to the ground, which constitutes a significant slipping hazard.

Other conventional parking stripes and signs can include directly adhering message bearing stickers to the pavement. However, such stickers tend to reduce traction to the ground, which constitutes a significant slipping hazard. Many such stickers tend to only partially adhere to the ground or lose adhesion, which constitutes a significant tripping hazard. Also, many stickers can lay so flat that they are not easily read by viewers. Further, removing the sticker tends to destroy the sticker, so that message is not reusable. Furthermore, any sticker that has an adhesive strong enough to withstand car tires tends to damage the painted stripe or concrete sealant onto which they've been placed when they are removed.

Speed bumps often have stickers on the surface of the speed bump to alert drivers of their presence and to advise drivers to drive slowly, but the dimensions of the speed bump would make the speed bump a tripping hazard if used for many applications, including parking stripes.

Also, conventional paint, ground stickers, and speed bumps tend to have poor visibility if the pavement area is poorly lit, which is a common issue for many parking garages and roads.

The pavement media platform of the present disclosure can provide for interchangeable messages, safety compliance, and ground durability. In an embodiment, the pavement media platform provides for interchangeable and/or reusable message display. For example, it has been found that using a pavement shell that includes polycarbonate allows for conventional bumper stickers coated with what is usually considered permanent adhesive to be tightly adhered to the top of the pavement shell, and yet, the sticker can be removed without tearing or leaving a portion on the pavement media platform. Moreover, the sticker can be removed without damaging the underlying object, which can allow for damage-free changing of the stickers as often as needed. In an embodiment, the pavement media platform can be designed to include a communication display, wherein the communication display includes a fastener, which can allow for messages or message materials to be reversibly and interchangeably fastened to the pavement media platform. A benefit of this design can include the reuse of the same message with no waste. In an embodiment, the pavement media platform can be designed to include a communication display that includes a light source, such as one or more lights or an array of lights. A benefit to a communication display containing lights can include conveying a message to a viewer using the lights or illuminating a message, such that the message can be readily perceived by a viewer.

In an embodiment, the pavement media platform includes a pavement shell having a height, width, and a traction feature which reduces the hazard of tripping to within safety compliance standards. In an embodiment, the pavement media platform includes a pavement shell and a pavement adhesive that are durable enough to withstand the repeated pressure of being run over by vehicles across the extreme hot and cold temperatures that parking structures are expected to withstand. In an embodiment, the pavement media platform includes a pressure-release ridge because it was discovered that that without the ridge the pavement shell tended to buckle and pop up when a tire was turned while on the stripe. In an embodiment, the ridge offers 3-dimensional rigidity to the stripe that keeps it from twisting like a ribbon when shearing stresses are applied by a turning tire. A benefit of the pressure-release ridge can include increasing the durability of the pavement media platform to eliminate or reduce twisting under the weight of vehicles.

Although the pavement media platform is designed for use on the ground of parking structures, a person of skill in the art will recognize that a pavement media platform could also be adhered to other environments, such as the walls or ceilings of parking garages, or the paved track of a golf course, a bike route, a sidewalk, or a road.

Various embodiments of the parking media platform are described herein.

### Adhesives of Various Embodiments

In an embodiment, the pavement communication platform includes a pavement adhesive. Such an adhesive may be adhered to at least a portion of a bottom surface of a pavement shell according to some embodiments. One such adhesive may include a tacky adhesive that can adhere to a bottom surface of a pavement shell and adhere directly to a pavement upon the adhesive being contacted with a pavement surface. In some embodiments, the pavement adhesive can be a tacky adhesive at 22.2° C. (72° F.) or a non-tacky adhesive at 22.2° C. (72° F.). In some embodiments, provided the adhesive is a tacky adhesive, the pavement communication platform includes a removable backing adhered to the pavement adhesive, wherein the pavement communication platform can be adhered to the pavement by detaching the removable backing from the pavement adhesive and placing the pavement adhesive in contact with the pavement. A benefit of a the removable backing can include eliminating or reducing accidental adhesion of the pavement adhesive to non-intended surfaces during shipping, storage, and handling. In other embodiments, the pavement adhesive can include a non-tacky adhesive, wherein the pavement communication platform can be adhered to the pavement by heating the pavement adhesive and placing the pavement adhesive in contact with the pavement. In some embodiments, the non-tacky pavement adhesive may be heated to a temperature from about 121° C. to about 176° C. to adhere the pavement adhesive to the pavement. In alternative embodiments, the non-tacky pavement adhesive may be heated to a temperature from about 130° C. to about 170° C., or from about 140° C. to about 160° C. Pavement adhesives according to various embodiments may be a single, homogenous material. In some embodiments, the pavement adhesive can include adhesive tapes or strips of a suitable length, width and thickness for adhering a pavement shell to a pavement.

In other embodiments, a sticker adhesive layer is provided that may be used to adhere a sticker having a message to a surface of a pavement communication platform, including a top surface of the pavement shell. In an embodiment, the sticker can have a message conveyed on base material, wherein the base material includes an adhesive on at least one surface of the sticker. In some embodiments, the sticker adhesive includes a permanent adhesive. In other embodiments, the sticker adhesive allows a reversible adhesion of the sticker. In yet other embodiments, a sticker adhesive layer may be adhered to a surface of a communication display of a pavement communication platform.

The pavement adhesive or sticker adhesive according to various embodiments herein may be formed from a single material, or from more than one material. Adhesive materials provided according to various embodiments may include a butyl rubber based adhesive, a polybutene, a polybutelene-1, a polyisobutene, an epoxy, or a combination thereof. Such adhesives can provide the advantages of favorable adhesion properties as well as durability, resilience against pressure under very low to very high temperatures, and resistance to moisture and ice.

### Pavement Shells of Various Embodiments

In an embodiment, the pavement communication platform includes a pavement shell. In an embodiment, the pavement shell has a top surface, a bottom surface, and optionally at least one side surface. In an embodiment, the pavement shell includes a pressure release ridge that extends from the top surface through a material of the pavement shell to the bottom surface to prevent, eliminate, or reduce twisting or deforming when pressure is placed on the pavement communication platform. In an embodiment, the pressure release ridge may extend along the length of the pavement shell, which may include extending from about 70% to 100% of the pavement shell length.

The dimensions of the pavement shell in various embodiments can be of any suitable dimensions to correspond to the desired dimensions of a pavement communication platform as provided herein. In some embodiments, the height of the pavement communication platform ranges from about 0.5 cm to about 3.0 cm. In other embodiments, the height of the pavement communication platform ranges from about 0.75 cm to about 2.5 cm, or from about 1.0 cm to about 2.0 cm. In an embodiment, the pavement shell thickness can range from about 0.3 cm to about 2.0 cm. In another embodiment, the width of the pavement shell can range from about 8.0 cm to about 18.0 cm. In other embodiments, the width of the pavement shell can range from about 10.0 cm to about 16.0 cm, or from about 12.0 cm to about 14.0 cm. In various embodiments herein, the dimensions of the pavement communication platform and the pavement shell are of a suitable height and width to provide a platform for communication, while being of a suitably low height and width to avoid presenting a tripping hazard after being adhered to pavement.

In some embodiments, the pavement shell has at least one traction feature on a top surface. Such a traction feature may be of a suitable traction height and width to prevent a hazard of slipping when stepping on the pavement shell. In some embodiments, the traction feature can have a traction height of about 0.7 mm to about 1.3 mm, and a traction width of about 1.3 mm to about 2.0 mm. In a possible embodiment, the traction feature can be a ridge that extends along at least a portion of the length of the pavement communication platform. In other embodiments, the traction feature may include a textured top surface of the pavement shell to give the top surface of the pavement shell the traction associated with sandpaper. In an embodiment, the traction feature can include raised domes or conical projections extending from the top surface, which can increase traction. In an alternative embodiment, the pavement shell has at least two traction features, the at least two traction features possibly being spaced an average of about 4.0 mm to about 8.0 mm apart to form a traction area. In another embodiment, the traction area covers from about 80% to 100% of the top surface of the pavement shell.

In alternative embodiments, a traction feature can be included on a top surface of a communication display that can be mounted onto a pavement shell of a pavement communication platform. In such an embodiment, the traction feature may be included on the communication display in addition to or instead of the pavement shell. In still another alternative embodiment, a traction feature can be included on a top surface of a sticker, a message, or a message material that may be adhered or fastened to a top surface of a pavement shell or a communication platform.

Embodiments of the pavement shell herein may provide adhesion contours on a bottom surface of the pavement shell. Such adhesion contours can allow for the pavement shell to more tightly grip the pavement adhesive.

The pavement shell in various embodiments herein may be formed from a single material, or may be formed from more than one material. The pavement shell may be formed from any suitable material according to various embodiments of the pavement communication platform, which in some embodiments may include a flexible plastic or a hard plastic material, or other material with suitable properties of durability and resistance to pressure and environmental stress. Such materials in some embodiments may be combined with a colored dye. In some embodiments, the pavement shell may be formed from a polycarbonate, a polyurethane, a polymethyl methacrylate, a polyethylene, a thermoplastic elastomer (TPE), a rubber, an acrylic, a tempered glass, or a combination thereof. In an embodiment, the acrylate has a molecular weight from about 2.5 million to about 9.5 million Daltons. In other embodiments, the pavement shell can be formed from a polyvinyl chloride or other hard plastic material.

Pavement communication platforms herein may in some embodiments include pavement shells adhered to pavement adhesives in the form of spools or rolls, from which desired lengths of the platforms may be cut for further use in adhering the pavement communication platforms to pavement.

### Pressure-Release Ridges of Various Embodiments

Embodiments of a pavement communication platform herein provide a pavement shell having at least one pressure-release ridge. The term “pressure” as used herein generally refers to the “forces” applied by a vehicle and can include such forces as weight, tension, and torque. The term “pressure-release ridge” or “pressure release ridge” can be used interchangeably throughout the present disclosure with the terms “force-dissipation ridge” or “force-resistance ridge.” In various embodiments, the pressure-release ridge is configured to be suitable to provide the pavement shell with the ability to expand with the pavement adhesive, and to absorb and dissipate energy from pressure or forces applied to the pavement shell by compressing and releasing the applied pressure, as in the weight applied by the tires of a vehicle driven over or parked on the pavement communication platform. In such embodiments, the pressure-release ridge can avoid twisting of the pavement shell material, and provide advantages of resilience and durability to the pavement communication platform.

The pavement communication platforms herein are advantageous in providing a communication platform for pavement while not presenting a tripping or slipping hazard, and at the same time, providing for resilience, durability and reusability of the platform. The height and width dimensions of the pavement communication platforms are such that the hazards of tripping over them are reduced to be complaint with safety standards, while these dimensions also provide a pressure-release mechanism to mitigate the effects of repeated driving of vehicles over the pavement communication platform or the repeated turning of wheels on top of the pavement communication platform.

Various dimensions of the pressure-release ridge are possible. In an embodiment, the pressure-release ridge extends through the pavement shell material from the top surface to the bottom surface and along the length of the pavement shell. In an embodiment, the pressure-release ridge extends from about 70% to 100% of a length of the pavement shell. In various embodiments, the pressure-release ridge has a width and a height suitable to provide the desired properties of expansion and weight or force dissipation. In an embodiment, the pressure-release ridge has a width ranging from about 10.0 mm to about 15.0 mm. In another embodiment, the pressure-release ridge has a width ranging from about 11.0 mm to about 14.0 mm. In another embodiment, the pressure-release ridge has a width ranging from about 12.0 mm to about 13.0 mm. In an embodiment, the pressure-release ridge has a height that extends from the top surface of the pavement shell by from about 4.0 mm to 8.0 mm. In another embodiment, the pressure-release ridge has a height of from about 4.5 mm to about 7.5 mm. In another embodiment, the pressure-release ridge has a height of from about 5.0 mm to about 7.0 mm. In an embodiment, the ratio of the height of the pressure-release ridge to the thickness of the pavement shell ranges from about 0.4 to about 0.6. If the height of the pressure-release ridge to the thickness of the pavement shell ratio falls about or below these values, then the pressure-release ridge may not adequately reduce twisting.

Various possible embodiments of the pressure-release ridge can include different configurations and material compositions. The pressure release ridge can extend up from a top surface of the pavement shell in a shape suitable for the absorption and release of energy from applied weight or pressure. Such a shape of the ridge can include a circular shape or an elliptical shape in some embodiments. Other embodiments may include a square shape or a triangular shape, or other polygonal shape. The shape of the ridge extending from a top surface of the pavement shell can, in other embodiments, differ from the shape of the ridge extending from a bottom surface of the pavement shell. In an embodiment, the ridge could have a circular shape along the top surface of the pavement shell, and a different shape extending from the bottom surface of the pavement shell, such as an elliptical shape or other shape, possibly including a flat shape parallel with the rest of the bottom surface of the pavement shell. In such embodiments, the thickness of the pavement shell material forming the pressure-release ridge can be different from the remainder of the pavement shell structure.

In various embodiments, the pressure-release ridge may be formed from a flexible plastic or a hard plastic material, or other material with suitable properties of durability and resistance to pressure and environmental stress. Such materials in some embodiments may be combined with a colored dye. In some embodiments, the pressure-release ridge may be formed from a polycarbonate, a polyurethane, a polymethyl methacrylate, a polyethylene, a thermoplastic elastomer (TPE), a rubber, an acrylic, a tempered glass, or a combination thereof. In an embodiment, the acrylate has a molecular weight from about 2.5 million to about 9.5 million Daltons. In other embodiments, the pressure-release ridge can be formed from a polyvinyl chloride or other hard plastic material.

Various embodiments of the pressure-release ridge may also include the formation of the pavement shell and the pressure-release ridge from the same materials, or from different materials, or any suitable combination of materials, including those materials in various embodiments that can form the pavement shell.

In some embodiments, the pressure-release ridge includes pressure-relief supports. In such embodiments, the pressure-relief supports enhance the ability of the pressure-release ridge to “pop up” against the depressive force of applied pressure, as from the weight of a vehicle. The pressure-relief supports provide support for the pressure-release ridge against the surface contacted by the supports, acting to direct a reflexive force up through the pressure-release ridge counteractive to applied pressure. In an embodiment, the pressure relief supports extend from opposite sides of the pressure-release ridge and from a bottom surface of the pavement shell to contact the pavement adhesive. In such an embodiment, the contact of the pressure-relief supports with the pavement adhesive aids in adhering to and stabilizing the position of the pavement shell relative to the pavement adhesive layer. In a possible embodiment, the pressure-relief supports can include contours that extend along the length of the pavement shell.

Various dimensions of the pressure-relief supports are possible. In an embodiment, the pressure-release supports extend from about 70% to 100% of a length of the pavement shell. In some embodiments, the supports can have a height of about 0.7 mm to about 1.3 mm, and a width of about 1.3 mm to about 2.0 mm. Various embodiments may include forming the pressure-relief supports from a single material, or from more than one material. In various embodiments, the pressure-relief supports may be formed from the same material or materials as the pavement shell, or from the same material or materials as another pressure-release ridge relief support, or from a different material or combination of materials.

### Communication Displays of Various Embodiments

Embodiments of a pavement communication platform herein can include a communication display. Such a communication display may be attached to the pavement communication platform by a fastener, which in some embodiments can be mounted on a surface of the pavement communication platform or on a surface of a pavement shell. In some embodiments, a pavement shell and message display fastened to the pavement shell together form the communication display.

The fastener of various embodiments may be of any suitable type for the attachment of a communication display to the pavement communication platform, wherein the attachment results in a pavement communication display that is of a height and width that does not present a tripping hazard. The fastener may provide a permanent attachment of a communication display to the platform, or alternatively a reversible attachment that can allow the replacement or interchange of a communication display or message. Such a fastener could be formed of one or more suitable materials, which in various embodiments could include an adhesive, a plastic weld, a clip, a groove track, screws, nails, nuts, bolts, plugs, or other suitable materials. In an embodiment, the fastener is a countersunk fastener wherein the countersunk fastener has a top of the fastener that is flush with or below the surrounding surface of the pavement shell. In an embodiment, a benefit of a countersunk fastener can include reducing tripping hazards.

Various embodiments herein provide the communication display in the form of a sticker. Such a sticker may be adhered directly to the top surface of a pavement shell. In an embodiment, a sticker may be adhered directly to the bottom surface of a pavement shell, provided the pavement shell is formed of a material that allows the message of the sticker to be visible through the pavement shell material. Stickers in embodiments herein may be adhered to a surface using a sticker base layer coated with a sticker adhesive according to embodiments of adhesives described herein. Such adhesives may allow either permanent or reversible attachment of the sticker to a surface of the pavement communication platform.

The fastener in some embodiments may attach a communication display reversibly to a pavement shell. In an embodiment, the fastener may be formed as a continuous portion of a pavement shell. In such embodiments, the fastener may extend as ridges or grooves above a top surface of a pavement shell, allowing a communication display to be attached to the pavement shell by snapping or sliding the display into the ridges or grooves. In a possible embodiment, the pavement shell can provide a reversible form of attachment of a communication display, to allow periodic replacement or changing out of various communication displays or messages.

Communication displays of embodiments herein can be of a variety of suitable structures and formed of one or more of a variety of suitable materials. In an embodiment, the communication display can be provided by a flexible sleeve, including a clear plastic sleeve, into which a message may be inserted so that the message is visible through the sleeve. In other embodiments, the communication display can include a sticker having a message, wherein the sticker may be adhered to a top surface of the communication display, or alternatively to a bottom surface of the communication display, provided the communication display is formed of a material such that the message of the sticker is visible through the communication display material.

In other embodiments, the communication display can include one or more arrays of lights mounted or countersunk on a top surface of a pavement shell, or alternatively the light arrays can be visible through the top surface of the pavement shell, wherein the light arrays form a visible message. Such light arrays can include a light-emitting diode (LED), including an organic light emitting diode, or display or array of light-emitting diodes connected to wires within the pavement shell. In an embodiment, the light-emitting diodes may be provided with instructions as to when to light up. The LEDs may emit light of the same or different colors simultaneously or at different times, to allow variations in the messages to be communicated. In other embodiments, the communication display can include a LED or luminescent material. Such light emitting communication displays may be used in combination with other types of communication displays as provided herein, to allow various messages to be visible under low light conditions. Such embodiments provide an advantage to the use of pavement communication platforms in low light areas, including parking garages or parking lots during the night time.

In an embodiment, the method includes providing a communication display fastened to a pavement shell, the pavement shell may include a pressure-relief support. The communication display in some embodiments may also include a pressure-relief support that complements the pavement shell pressure-relief support and allows the attachment of the communication display onto a top surface of the pavement shell. In an embodiment, the communication display can be formed of the same or different materials as the pavement shell, may have dimensions that are the same as or similar to those of the pavement shell, and may have a pressure-relief support of a complementary shape that fits over the pavement shell pressure-relief support. In alternative embodiments, the communication display may not include or exclude a pressure-relief support, in, for example, embodiments wherein the communication display is formed such that attachment to the pavement shell will not interfere with the functioning of the pressure-relief support of the pavement shell. In an embodiment, the communication display can be provided by a sticker, or a flexible adhesive material. In yet another embodiment, the communication display can include a pressure-relief support, while the pavement shell can include or exclude a pressure relief support.

### Methods of Embodiments Herein

Various embodiments herein present methods of communicating by displaying a message on a pavement communication platform. Such methods may be practiced using the various embodiments of the pavement communication platforms disclosed herein. In an embodiment of the method, the communicating is accomplished by adhering a pavement communication platform to a pavement and displaying a message on the pavement communication platform, wherein the pavement communication platform includes a pavement adhesive and a pavement shell, where the pavement shell has at least one pressure-release ridge and at least one traction feature on a top surface. In such embodiments, the pavement adhesive may be a tacky adhesive that adheres to the pavement by detaching a removable backing from the pavement adhesive and placing the pavement adhesive in contact with the pavement. In other embodiments, the pavement adhesive may be a non-tacky adhesive, where the adhering is performed by heating the pavement adhesive to a suitable temperature, and placing the pavement adhesive in contact with the pavement.

In another embodiment method, the message is displayed by adhering a sticker having a message to a surface of the pavement shell, wherein the sticker includes a sticker base material and a sticker adhesive layer. The sticker base material may be formed of one or more of any suitable adhesive materials, including but not limited to, a polyvinylchloride, a polyester, or combination thereof. The sticker adhesive may include a permanent adhesive. In an embodiment, the sticker may include an adhesive that will allow reversible attachment of the sticker to the surface of the pavement shell. In an embodiment, the sticker is adhered directly to a top surface of the pavement shell.

Another method embodiment provides that the pavement communication platform includes a communication display having a fastener mounted on a top surface of the pavement communication platform. In an embodiment, the message is displayed by fastening a material having a message onto the communication display. In an embodiment, the fastener is a traction feature on the top surface of the pavement shell. In an embodiment, the material having the message is attached to a pavement shell, wherein the fastener is mounted on or incorporated into the structure of the pavement shell. In an embodiment, the message is mounted on the structure of the pavement shell and the message has a traction feature on a top surface of the message or message material.

In an alternative embodiment, the communication display includes an array of lights that is mounted on the top surface of a pavement shell, and the message or communication is displayed by illuminating at least part of the array of lights.

In an embodiment, a pavement communication platform includes a pavement adhesive; and a pavement shell, wherein the pavement shell has a top surface and a bottom surface, and at least a portion of the bottom surface is adhered to the pavement adhesive, wherein the pavement shell has at least one pressure-release ridge that extends from the top surface through a material of the pavement shell to the bottom surface and extends from about 70% to 100% of a length of the pavement shell. In an embodiment, the pavement communication platform includes at least one traction feature on the top surface of the pavement shell or a top surface of the message or communication platform.

### EXAMPLES

This example illustrates the construction and performance testing of a pavement communication platform according to the embodiments described herein. A pavement shell was formed from LEXAN® polycarbonate in a configuration according to that shown in FIG. 1 (having a height 60 mm, width 10.16 cm, and length 5.4 m) and adhered on the bottom surface to a DEVAN® high-strength, butyl rubber-based, instant grab adhesive (having a height 30 mm, width 9.9 cm, and length of 5.4 m). The DEVAN® adhesive has a removable backing that is peeled off the adhesive layer before application to pavement.

A second example illustrates the construction and performance testing of a pavement communication platform according to the embodiments described herein. A pavement shell was formed from a lower piece of polyethylene base, a LEXAN® polycarbonate top snap-in top piece in a configuration according to that shown in FIG. 2 (having a height 60 mm, width 10 cm, and length of three 1.8 m sections but jointed together to equal 5.4 m in total length) and adhered on the bottom surface to a DEVAN® high-strength, butyl rubber-based, instant grab adhesive (having a height 30 mm, width 9.9 cm, and length of three 1.8 m foot sections). The DEVAN® adhesive has a removable backing that is peeled off the adhesive layer before application to pavement.

A third example illustrates the construction and performance testing of a pavement communication platform according to the embodiments described herein. A pavement shell was formed from a lower piece of LEXAN® polycarbonate as follows: a LEXAN® polycarbonate top snap-in top piece was assembled into a configuration according to that shown in FIG. 2 (wherein the LEXAN® polycarbonate top piece had a height 120 mm, width 16.5 cm, and length of three 1.8 m sections, but were joined together to equal 5.4 m in total length) by adhering the bottom surface to a hot melt DEVAN® high-strength, butyl rubber-based, instant grab adhesive. The hot-melt adhesive was applied in conjunction with the placement of the stripe wherein the hot glue was placed on the pavement surface and the stripe was placed on top of the hot-melt adhesive before it cooled and set.

The pavement communication platform was adhered to a smooth, clean, flat pavement surface. The performance of the platform was tested by driving a vehicle laterally over the platform a number of times before the degree of any twisting or deforming of the pavement shell was assessed.

What is claimed is:

1. A pavement communication platform comprising:
a pavement adhesive; and
a pavement shell,
wherein the pavement shell has a top surface and a bottom surface, and at least a portion of the bottom surface is adhered to the pavement adhesive,
wherein the pavement shell has at least one pressure-release ridge that extends from the top surface through a material of the pavement shell to the bottom surface and extends from about 70% to 100% of a length of the pavement shell; and
wherein the pavement shell has at least one traction feature on the top surface.

2. The pavement communication platform of claim 1, wherein the height of the pavement communication platform ranges from about 0.5 cm to about 3.0 cm;
wherein the thickness of the pavement shell ranges from about 0.3 cm to about 2.0 cm;
wherein the width of the pavement shell ranges from about 8.0 cm to about 18.0 cm; or
wherein the at least one traction feature has a traction height of about 0.7 mm to about 1.3 mm and a traction width of about 1.3 mm to about 2.0 mm.

3. The pavement communication platform of claim 1, wherein the at least one pressure-release ridge has a ridge width ranging from about 10.0 mm to about 15.0 mm and a ridge height that extends from the top surface by from about 4.0 mm to 8.0 mm.

4. The pavement communication platform of claim 1, wherein the pavement shell has at least two traction features, and the at least two fraction features are spaced an average of about 4.0 mm to about 8.0 mm apart to form a traction area, and the traction area covers from about 80% to 100% of the top surface of the pavement shell.

5. The pavement communication platform of claim 1, wherein the material of the pavement shell includes a polycarbonate, a polyurethane, a polymethyl methacrylate, a polyethylene, a thermoplastic elastomer, a rubber, an acrylic having a molecule weight from about 2.5 million to about 9.5 million Daltons, a tempered glass, or a combination thereof; or
the pavement adhesive includes a polybutene, a polybutelene-1, a polyisobutene, an epoxy, or a combination thereof.

6. The pavement communication platform of claim 1, wherein at least one of the pavement adhesive and the pavement shell is formed from a single material.

7. The pavement communication platform of claim 1,
provided the pavement adhesive is a tacky adhesive,
the pavement communication platform further comprises a removable backing adhered to the pavement adhesive.

8. The pavement communication platform of claim 1, further comprising:
a sticker adhered to the top surface of the pavement communication platform,
wherein the sticker includes a sticker base material and a sticker adhesive layer,
wherein the sticker base material includes a polyvinylchloride, a polyester, or a combination thereof; and
the sticker adhesive includes a permanent adhesive.

9. The pavement communication platform of claim 1, further comprising: a communication display, wherein the communication display includes a fastener mounted of the top surface of the pavement communication platform.

10. The pavement communication platform of claim 1, further comprising: a communication display, wherein the communication display includes an array of lights that is mounted on the top surface of the pavement shell or visible through the top surface of the pavement shell.

11. A method of communicating comprising:
adhering a pavement communication platform to a pavement; and
displaying a message on the pavement communication platform,
wherein the pavement communication platform includes:
a pavement adhesive; and
a pavement shell,
wherein the pavement shell has a top surface and a bottom surface, and at least a portion of the bottom surface is adhered to the pavement adhesive,
wherein the pavement shell has at least one pressure-release ridge that extends from the top surface through a material of the pavement shell to the bottom surface and extends from about 70% to 100% of a length of the pavement shell; and
wherein the pavement shell has at least one traction feature on the top surface.

12. The method of communicating of claim 11,
provided that the pavement adhesive is a tacky adhesive and the pavement adhesive is adhered to a removable backing,
adhering the pavement communication platform to the pavement by detaching the removable backing from the pavement adhesive and placing the pavement adhesive in contact with the pavement.

13. The method of communicating of claim 11,
provided that the pavement adhesive is a non-tacky adhesive,
adhering the pavement communication platform to the pavement by heating the pavement adhesive to from about 121° C. to about 176° C. and placing the pavement adhesive in contact with the pavement.

14. The method of communicating of claim 11,
displaying the message by adhering a sticker having a message to a top surface of the pavement shell,
wherein the sticker includes a sticker base material and an sticker adhesive layer,
wherein the sticker base material includes a polyvinylchloride, a polyester, or a combination thereof; and
the sticker adhesive includes a permanent adhesive.

15. The method of communication of claim 11,
provided that the pavement communication platform includes a communication display, wherein the communication display includes a fastener mounted on the top surface of the pavement communication platform,
displaying the message by fastening a material having a message onto the communication display; or
provided that the pavement communication platform includes a communication display, wherein the communication display includes an array of lights that is mounted on the top surface of the pavement shell or visible through the top surface of the pavement shell,
displaying a message by illuminating at least part of the array of lights.
